(19) United States
(12) Patent Application Publication
(10) Pub. No.: US 2018/0198575 A1
(43) Pub. Date: Jul. 12, 2018

(54) SYNCHRONIZATION SIGNAL TRANSMISSION AND RECEPTION FOR RADIO SYSTEM

(71) Applicant: SHARP Laboratories of America, Inc., Camas, WA (US)

(72) Inventors: Jia SHENG, Vancouver, WA (US); Tatsushi AIBA, Vancouver, WA (US); Toshizo NOGAMI, Vancouver, WA (US)

(21) Appl. No.: 15/860,320

(22) Filed: Jan. 2, 2018

Related U.S. Application Data
(60) Provisional application No. 62/443,622, filed on Jan. 6, 2017.
(60) Provisional application No. 62/453,986, filed on Feb. 2, 2017.

(51) Int. Cl. H04L 5/00; H04J 11/00; H04W 48/16

(52) U.S. Cl. CPC H04L 5/005; H04J 11/0073; H04W 48/16; H04J 11/0079; H04J 11/0076

(57) ABSTRACT

In one of its aspects the technology disclosed herein concerns a wireless terminal comprising receiving circuitry. The receiving circuitry is configured to receive, from a base station apparatus, a block of synchronization signals and a physical broadcast channel, the block composing a first sequence and a second sequence and a third sequence and a physical broadcast channel. The first sequence and the second sequence are used for identifying a physical layer cell identity, the first sequence being provided from 3 sequences, the second sequence being provided from 336 sequences. An index of the block is at least partially determined based on the third sequence

This application claims the priority and benefit of (1) U.S. Provisional Patent application 62/443,622 filed Jan. 6, 2017, entitled “SYNCHRONIZATION SIGNAL TRANSMISSION FOR RADIO SYSTEM”, and (2) U.S. Provisional Patent Application 62/453,986; filed Feb. 2, 2017, entitled “SYNCHRONIZATION SIGNAL TRANSMISSION FOR RADIO SYSTEM”, both of which are incorporated herein by reference in their entirety.

### TECHNICAL FIELD

The technology relates to wireless communications, and particularly to methods and apparatus for requesting, transmitting, and using system information (SI) in wireless communications.

### BACKGROUND

In wireless communication systems, a radio access network generally comprises one or more access nodes (such as a base station) which communicate on radio channels over a radio or air interface with plural wireless terminals. In some technologies such a wireless terminal is also called a User Equipment (UE). A group known as the 3rd Generation Partnership Project (“3GPP”) has undertaken to define globally applicable technical specifications and technical reports for present and future generation wireless communication systems. The 3GPP Long Term Evolution (“LTE”) and 3GPP LTE Advanced (LTE-A) are projects to improve an earlier Universal Mobile Telecommunications System (“UMTS”) mobile phone or device standard in a manner to cope with future requirements.

Work has started in the International Telecommunications Union (ITU) and 3GPP to develop requirements and specifications for new radio (NR) 5G systems, e.g., fifth generation systems. Within the scope of 3GPP, a new study item (SID) “Study on New Radio Access Technology” has been approved. The timeline and the study situations of NR development are summarized in RP-161596, “Revision of SI: Study on New Radio Access Technology”, 3GPP TSG RAN Meeting #73, New Orleans, Sep. 19-22, 2016, which is incorporated herein by reference. In order to fulfill 5G requirements, changes with regard to 4G LTE system have been proposed for study, such as higher frequency spectrum usage (e.g., 6 GHz, 40 GHz or up to 100 GHz), scalable numerology (e.g., different subcarrier spacing (SCS), 3.75 KHz, 7.5 KHz, 15 KHz (current LTE), 30 KHz . . . possibly 480 KHz), beam based initial access (one traditional cell may contain multiple beams due to the particular beamforming adopted).

In LTE system, three primary synchronization sequences (PSS) sequences provide identification of cell ID (0-2); and secondary synchronization sequences (SSS) sequences provide identification of cell ID group (0-167). Therefore, in all 168*3 =504 Physical Cell ID (PCI) IDs are supported in the LTE system. In a RAN1 #87 meeting, it was pointed out that “Number of IDs provided by NR-PSS/SSS” should be studied. See, e.g., 3GPP RAN1 #87 Chairman's Notes, which is incorporated herein by reference. Further, in RAN1 # 86 meeting, it was agreed that “Detection of NR cell and its ID. See, e.g., 3GPP RAN1 #86 Chairman's Notes, which is incorporated herein by reference.

It is anticipated that in the next generation new radio (NR) technology, a cell may correspond to one or multiple transmission and reception point (TRPs). This means that multiple TRPs may share the same NR cell ID, or that each transmission and reception point (TRP) may have its own identifier. Further, the transmission of one TRP can be in the form of single beam or multiple beams. Each of the beams may also possibly have its own identifier. FIG. 2 provides a simple example depiction of a relationship between a cell, transmission and reception point(s) (TRP(s)), and beam(s).

In view of the foregoing, it is problematic as to how PSS/SSS as presently used, or even a potential Physical Broadcast Channel (PBCH) can provide identifiers, as well as what type of identifiers, to be associated signal design for initial access in new radio (NR) technology.

It has been agreed in RAN1 #86bis meeting (See, e.g., 3GPP RAN1 #86bis Chairman's Notes, which is incorporated herein by reference) that:
PSS, SSS and/or PBCH can be transmitted within a ‘SS block’
   Multiplexing other signals are not precluded within a ‘SS block’
One or multiple ‘SS block(s)’ compose an ‘SS burst’
One or multiple ‘SS burst(s)’ compose a ‘SS burst set’
   The Number of SS bursts within a SS burst set is finite.
From RAN1 specification perspective, NR air interface defines at least one periodicity of SS burst set (Note: Interval of SS burst can be the same as interval of SS burst set in some cases, e.g., single beam operation)
   FIG. 3 is an example NR SS block structure according to the RAN1 #86bis meeting. In FIG. 3, “synchronization signal burst set/series” represents a “SS burst set”. Additional detailed examples are illustrated in R1-1610522, “WF on the unified structure of DL sync signal”, Intel Corporation, NTT DOCOMO, ZTE, ZTE Microelectronics, ETRI, InterDigital, Lisbon, Portugal, 10-14Oct. 2016, which is incorporated herein by reference. According to R1-1611268, “Considerations on SS block design”, ZTE, ZTE Microelectronics, Reno, USA, Nov. 2016, 14-18, 2016, which is incorporated herein by reference, the structure of the SS block of FIG. 3 may be as shown in FIG. 4.

According to 3GPP RAN1 #87 Chairman's Notes, it has been further agreed in 3GPP RAN1 #87 Chairman's Notes, incorporated herein by reference, that:
At least for multi-beams case, at least the time index of SS-block is indicated to the UE
From the UE perspective, SS burst set transmission is periodic, and that at least for initial cell selection, the UE may assume a default periodicity of SS burst set transmission for a given carrier frequency

Here PSS/SSS and PBCH have different periodicity due to different detection performance requirements and different methods to combat channel distortion (PBCH has channel coding and repetition to combat channel distortion, while PSS/SSS does not). The multiplexing methods described in R1-1611268, “Considerations on SS block design”, ZTE, ZTE Microelectronics, Reno, USA, Nov. 2016, 14-18, 2016 and FIG. 4 cannot work directly, as it is possible that either PSS/SSS or PBCH is not included in that SS block.

What is needed, therefore, and examples object of the technology disclosed herein, are methods, apparatus, and techniques for one or more of flexible and systematic NR synchronization signal design; flexibly hierarchical IDs for 5G system (given the fact that the 5G system may require more IDs for UEs to recognize and access network); and multiplexing NR-PSS/SSS and NR-PBCH in a SS block (given that both of them may not always be included in the SS block); as well as designing the associated UE behaviors.

### SUMMARY

In an example embodiment and mode the technology disclosed herein concerns a user equipment (UE). The user equipment (UE) comprises receiving circuitry configured to receive, from a base station apparatus, a block of synchronization signals and a physical broadcast channel, the block composing a first sequence and a second sequence and a third sequence and a physical broadcast channel. The first sequence and the second sequence are used for identifying a physical layer cell identity, the first sequence being provided from 3 sequences, the second sequence being provided from 336 sequences. An index of the block is at least partially determined based on the third sequence.

In another of its example embodiments and modes the technology disclosed herein concerns a base station apparatus comprising transmitting circuitry. The transmitting circuitry is configured to transmit, to a user equipment, a block of synchronization signals and a physical broadcast channel, the block composing a first sequence and a second sequence and a third sequence and a physical broadcast channel. The first sequence and the second sequence are used for identifying a physical layer cell identity, the first sequence being provided from 3 sequences, the second sequence being provided from 336 sequences. An index of the block is at least partially based on the third sequence.

In others of its example embodiments and modes, a method in a UE and a method in a base station are also provided.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view showing information utilized in an initial access procedure.

FIG. 2 is a diagrammatic view showing an example relationship between a cell, transmission and reception point(s) (TRP(s)), and beam(s).

FIG. 3 is a diagrammatic view showing example NR SS block structure according to the RAN1 #86bis meeting.

FIG. 4 is a diagrammatic view showing example structure of the SS block of FIG. 3.

FIG. 5A-FIG. 5E are schematic views showing an example communications system comprising differing configurations of radio access nodes and a wireless terminal, and wherein the radio access nodes provide transmitting entity identity information comprising differing types of transmitting identifiers.

FIG. 5F is a schematic view showing an example communications system wherein a wireless terminal obtains a beam identifier (BID) and uses the beam identifier (BID) to obtain a synchronization signal block time index.

FIG. 6 is a flowchart showing example, non-limiting, representative acts or steps performed by the access node of any one of the example embodiments and modes of FIG. 5A-FIG. 5E.

FIG. 7 is a flowchart showing example, non-limiting, representative acts or steps performed by the wireless terminal of any one of the example embodiments and modes of FIG. 5A-FIG. 5E.

FIG. 8 shows how an access node, such as any one of the access nodes of FIG. 5A-FIG. 5F or another other access node, may be configured to multiplex transmitting entity identity information into SS blocks.

FIG. 9 is a diagrammatic view showing differing alternative ID assignment techniques according to example embodiments and modes.

FIG. 10-1 through FIG. 10-4 are diagrammatic views illustrating example, non-limiting implementations of ID assignment techniques B.1 through B.4, respectively. FIG. 10-4-1 through FIG. 10-4-2 are diagrammatic views illustrating example, non-limiting implementations of ID assignment techniques B.4.1 and B.4.2, respectively.

FIG. 11 is a diagrammatic view showing a synchronization signal block burst set comprising synchronization signal block bursts, as well as a relationship between beam identifiers and synchronization signal block time indexes.

FIG. 12 is a flowchart showing example, non-limiting, representative acts or steps performed by the wireless terminal 26F of FIG. 5F.

FIG. 13 is a diagrammatic view showing example electronic machinery which may comprise node electronic machinery or terminal electronic machinery.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc.

As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, netbooks, tablets, e-readers, wireless modems, etc.

As used herein, the term “access node”, “node”, or “base station” can refer to any device or group of devices that facilitates wireless communication or otherwise provides an interface between a wireless terminal and a telecommunications system. A non-limiting example of an access node may include, in the 3GPP specification, a Node B (“NB”), an enhanced Node B (“eNB”), a home eNB (“HeNB”), or (in the 5G terminology) a gNB or even a transmission and reception point (TRP), or some other similar terminology. Another non-limiting example of a base station is an access point. An access point may be an electronic device that provides access for wireless terminal to a data network, such as (but not limited to) a Local Area Network (“LAN”), Wide Area Network (“WAN”), the Internet, etc. Although some examples of the systems and methods disclosed herein may be described in relation to given standards (e.g., 3GPP Releases 8, 9, 10, 11, . . . ), the scope of the present disclosure should not be limited in this regard. At least some aspects of the systems and methods disclosed herein may be utilized in other types of wireless communication systems.

As used herein, the term “telecommunication system” or “communications system” can refer to any network of devices used to transmit information. A non-limiting example of a telecommunication system is a cellular network or other wireless communication system.

As used herein, the term “cellular network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”). All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information.

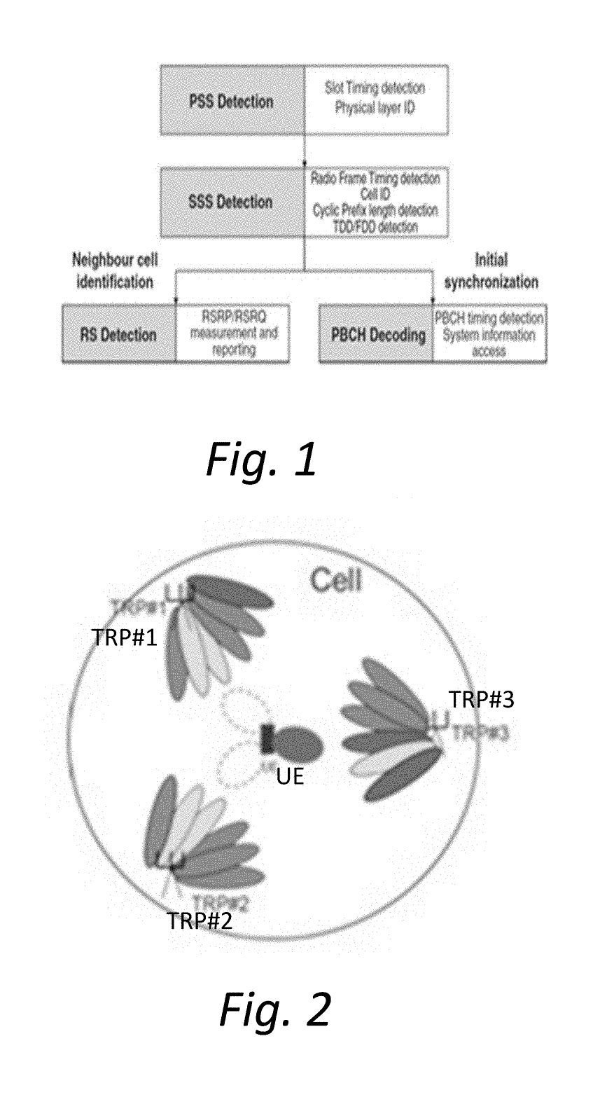

Here hierarchical synchronization signals, i.e., primary synchronization sequences (PSS) and secondary synchronization sequences (SSS) provide coarse time/frequency synchronization, physical layer cell ID (PCI) identification, subframe timing identification, frame structure type (FDD or TDD) differentiation and cyclic prefix (CP) overhead identification. In such systems, a physical broadcast channel (PBCH) provides further information, such as system frame number (SFN) and essential system information so that a wireless terminal (e., UE) can obtain information to access the network. An initial access procedure for such systems is illustrated in FIG. 1.

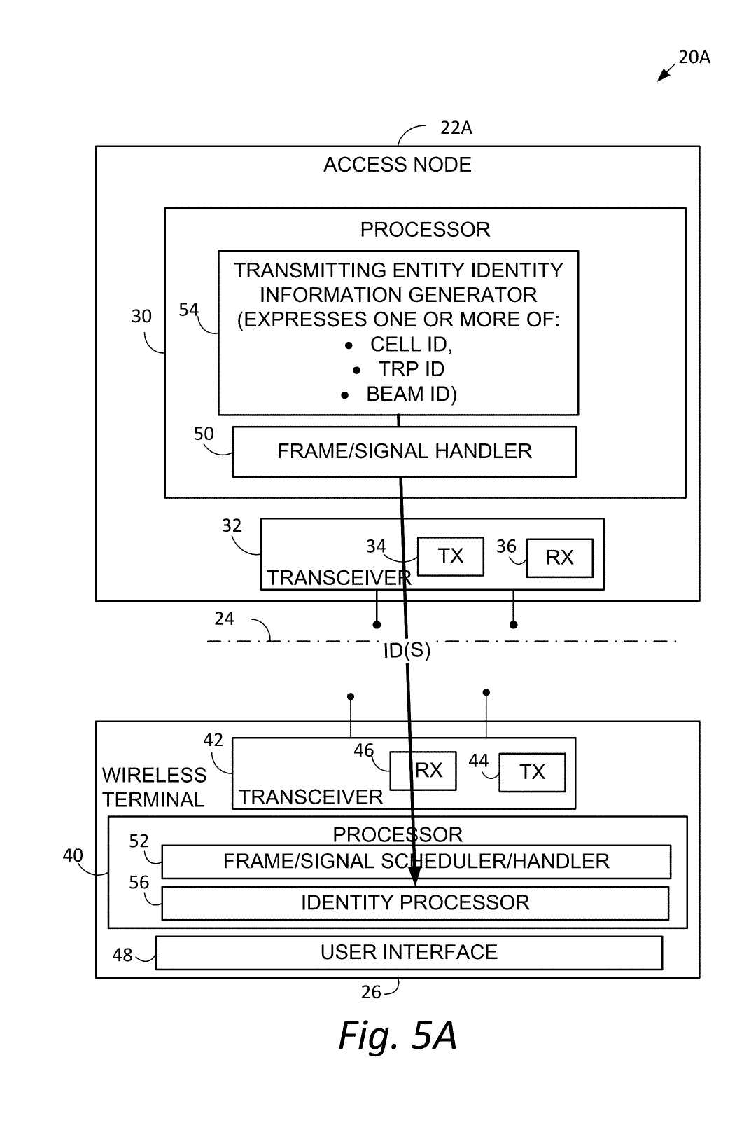

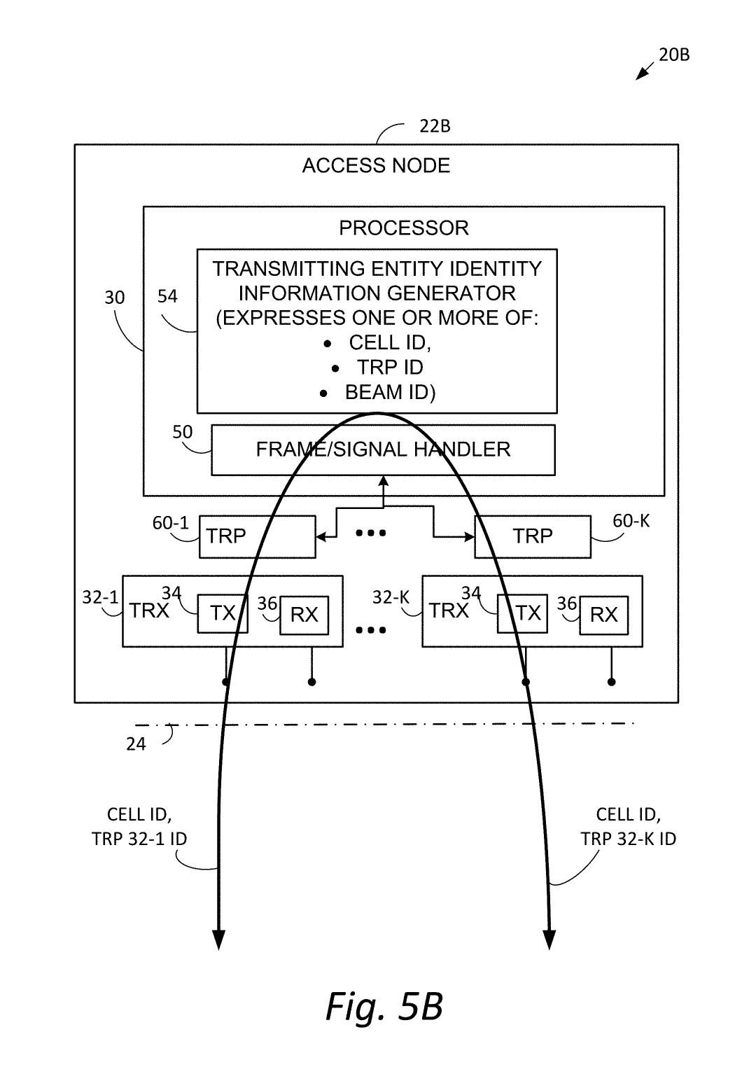

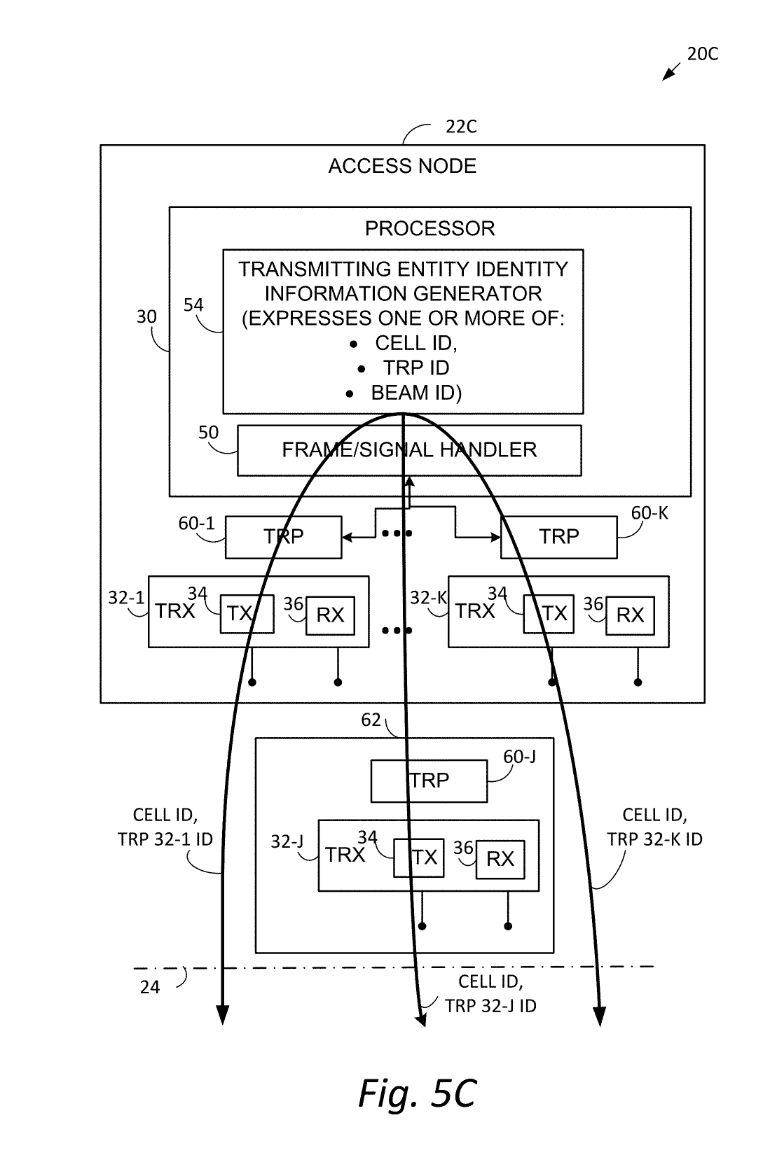

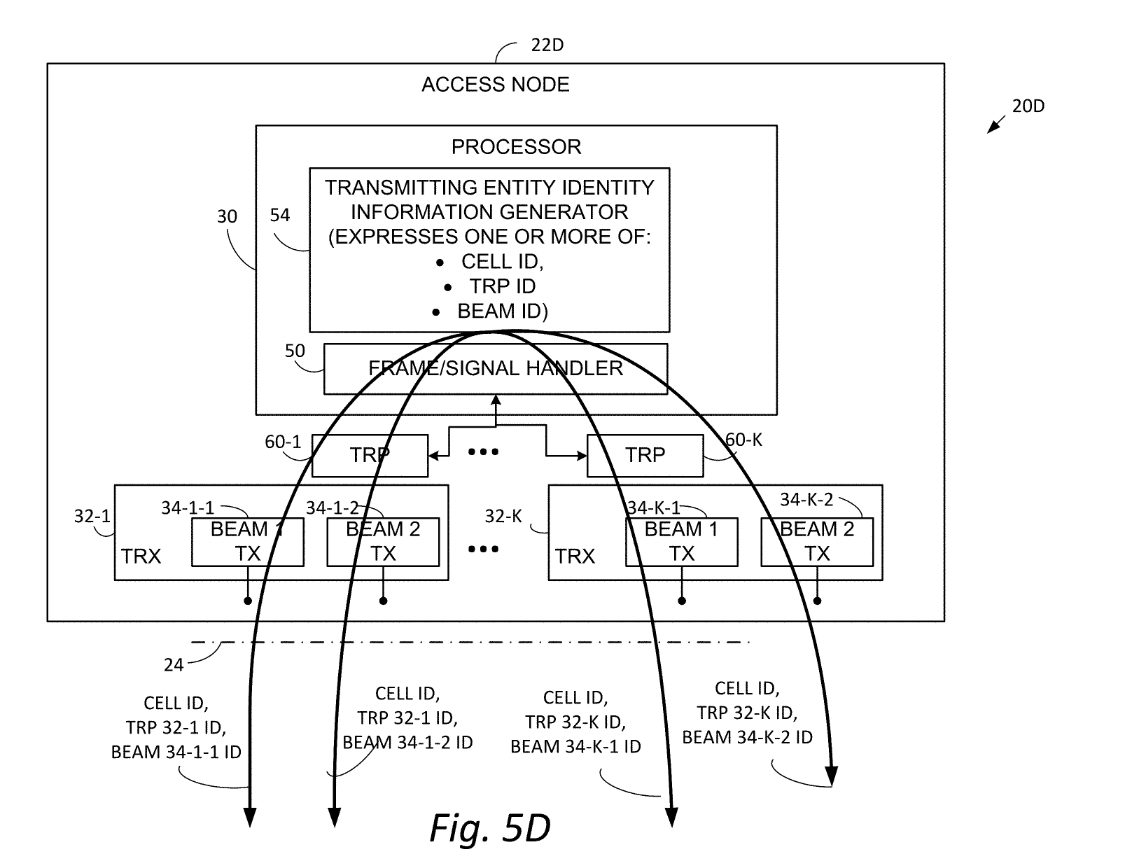

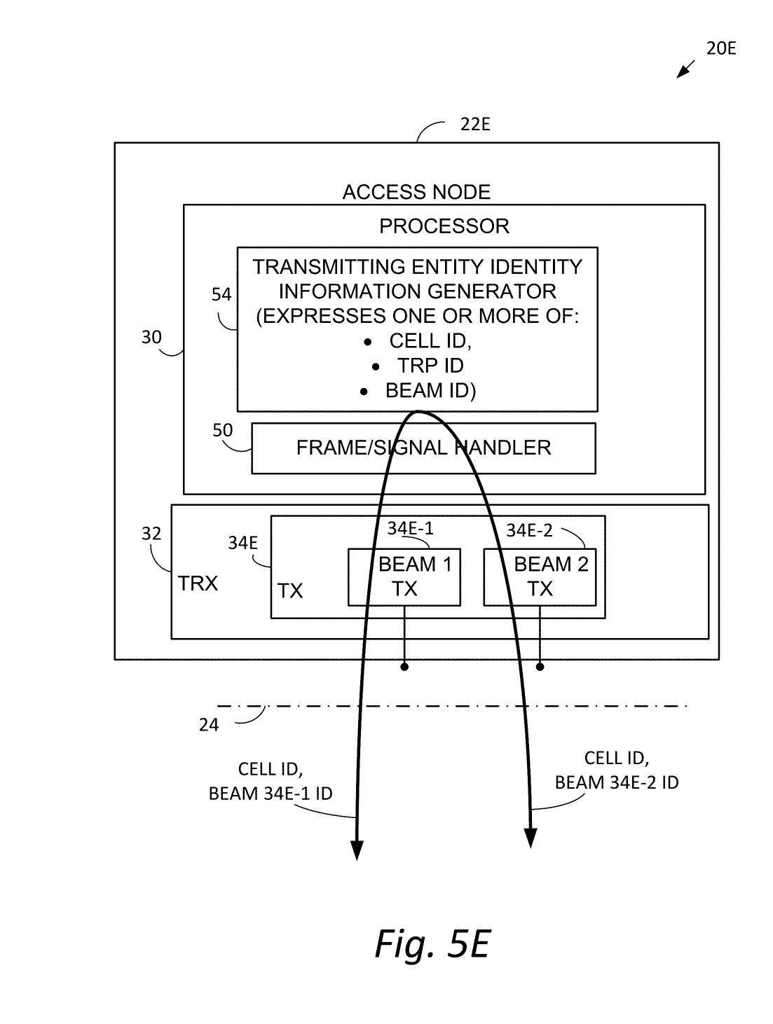

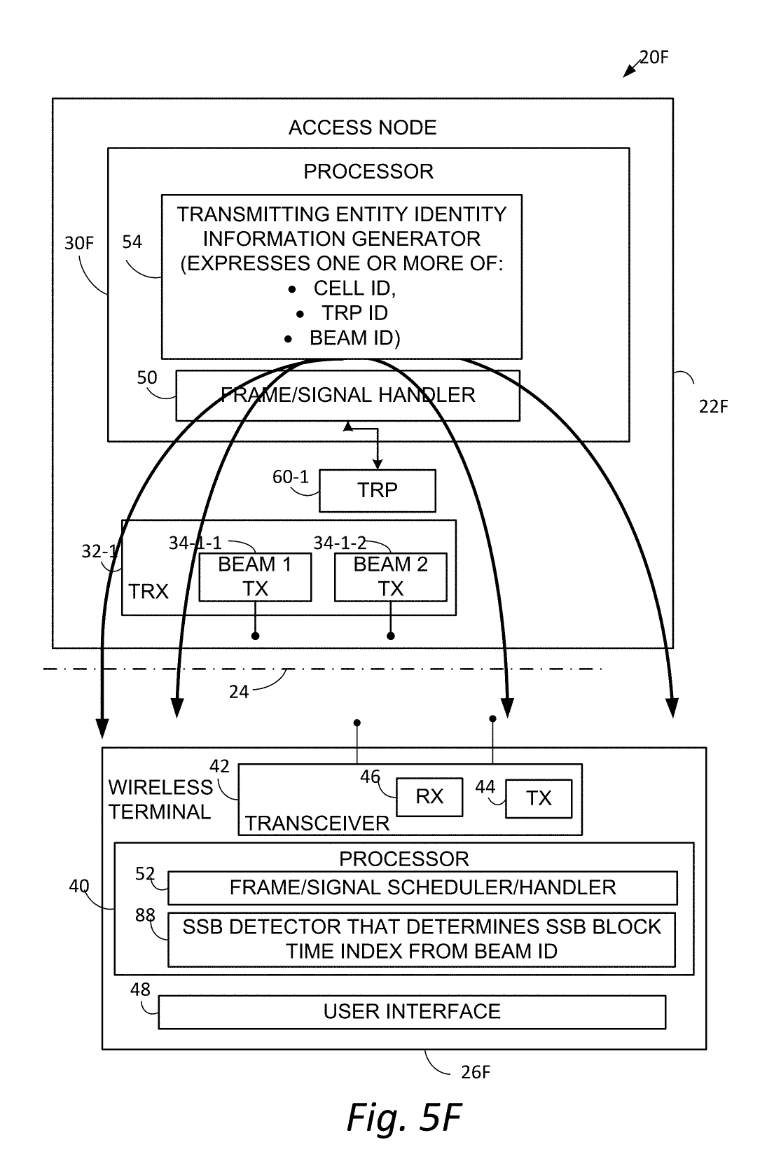

FIG. 5A shows an example communications system 20A wherein radio access node 22A communicates over air or radio interface 24 (e.g., Uu interface) with wireless terminal 26. As mentioned above, the radio access node 22A may be any suitable node for communicating with the wireless terminal 26, such as a base station node, or eNodeB (“eNB”) or gNodeB or gNB, for example. The node 22A comprises node processor circuitry (“node processor 30”) and node transceiver circuitry 32. The node transceiver circuitry 32 typically comprises node transmitter circuitry 34 and node receiver circuitry 36, which are also called node transmitter and node receiver, respectively.

The wireless terminal 26 comprises terminal processor 40 and terminal transceiver circuitry 42. The terminal transceiver circuitry 42 typically comprises terminal transmitter circuitry 44 and terminal receiver circuitry 46, which are also called terminal transmitter 44 and terminal receiver 46, respectively. The wireless terminal 26 also typically comprises terminal user interface 48. The terminal user interface 48 may serve for both user input and output operations, and may comprise (for example) a screen such as a touch screen that can both display information to the user and receive information entered by the user. The user interface 48 may also include other types of devices, such as a speaker, a microphone, or a haptic feedback device, for example.

For both the radio access node 22A and radio interface 24, the respective transceiver circuitries 22 include antenna(s). The respective transmitter circuits 34 and 44 may comprise, e.g., amplifier(s), modulation circuitry and other conventional transmission equipment. The respective receiver circuits 36 and 46 may comprise, e.g., e.g., amplifiers, demodulation circuitry, and other conventional receiver equipment.

In general operation node, access node 22A and wireless terminal 26 communicate with each other across radio interface 24 using predefined configurations of information. By way of non-limiting example, the radio access node 22A and wireless terminal 26 may communicate over radio interface 24 using “frames” of information that may be configured to include various channels. In Long Term Evolution (LTE), for example, a frame, which may have both downlink portion(s) and uplink portion(s), may comprise plural subframes, with each LTE subframe in turn being divided into two slots. The frame may be conceptualized as a resource grid (a two dimensional grid) comprised of resource elements (RE). Each column of the two dimensional grid represents a symbol (e.g., an OFDM symbol on downlink (DL) from node to wireless terminal; an SC-FDMA symbol in an uplink (UL) frame from wireless terminal to node). Each row of the grid represents a subcarrier. The frame and subframe structure serves only as an example of a technique of formatting of information that is to be transmitted over a radio or air interface. It should be understood that “frame” and “subframe” may be utilized interchangeably or may include or be realized by other units of information formatting, and as such may bear other terminology (such as blocks, or symbol, slot, mini-slot in 5G for example).

To cater to the transmission of information between radio access node 22A and wireless terminal 26 over radio interface 24, the node processor 30 and terminal processor 40 of FIG. 1 are shown as comprising respective information handlers. For an example implementation in which the information is communicated via frames, the information handler for radio access node 22A is shown as node frame/signal scheduler/handler 50, while the information handler for wireless terminal 26 is shown as terminal frame/signal handler 52.

In the technology disclosed herein a particular wireless terminal 26 may need to camp on a transmission from a particular transmission reception point TRP or a particular beam of a cell. For camping purposes, the wireless terminal 26 may need to identify the particular transmission reception point TRP or a particular beam of a cell for such camping, which means that a separate identifier needs to be provided for the particular transmission reception point TRP and/or for a particular beam of a cell.

The node processor 30 of radio access node 22 also includes transmitting entity identity information generator 54. The transmitting entity identity information which is generated by transmitting entity identity information generator 54 may express one or more of plural types of transmission identifiers, such as transmission identifiers associated with the access node 22A. The plural types of transmission identifiers may comprise, for example, a physical layer cell identifier (PCID) and one or more of a transmission and reception point identifier (TRP ID) and a beam identifier (BID). For the transmission of such ID information between access node and wireless terminal, the access node will only assign one PCID, and/or one TRP ID, and/or one beam ID for the UE to identify where it will camp on. The concept of transmitting entity identity information is intended to cover plural types of transmission identifiers, even if the plural types of transmission identifiers are not separately named but are collectively encompassed in one identifier (e.g., the transmitting entity identity information). The concept of transmitting entity identity information also may cover transmission identifiers beyond the 504 physical layer cell identifiers (PCIDs) of LTE, e.g., beyond the “original” or LTE meaning of cell identifier. In the example access node 22A of FIG. 5A, the transmitting entity identity information generator 54 may generate transmitting entity identity information which comprises a PCID. FIG. 5B-FIG. 5D, described below, illustrate other types of transmission identifiers.

FIG. 5B illustrates an access node 22B which comprises plural ports, which may be associated with (for example) respective plural transmission and reception points (TRPs) 60. For example, FIG. 5B shows K integer number of transmission and reception points (TRPs), e.g., TRP 60-1 through TRPB 60-K, associated with access node 22B. Each transmission and reception point (TRP) 60 comprises its own transceiver 32, e.g., transmission and reception point (TRP) 60-1 comprises TRP transceiver 32-1 and transmission and reception point (TRP) 60-K comprises TRP transceiver 32-K. The transmitting entity identity information transmitted through TRP transceiver 32-1 for TRP 60-1, as generated by transmitting entity identity information generator 54, expresses the physical layer cell identifier (PCID) associated with the cell served by access node 22B, as well as the transmission and reception point identifier (TRP ID #1) associated with transmission and reception point (TRP) 60-1. Similarly, the transmitting entity identity information transmitted through TRP transceiver 32-K, as generated by transmitting entity identity information generator 54, expresses the physical layer cell identifier (PCID) associated with the cell served by access node 22B, as well as the transmission and reception point identifier (TRP ID #K) associated with transmission and reception point (TRP) 60-K.

FIG. 5B depicts a situation in which the transmission and reception points (TRP) 60 are collocated with the portion of access node 22B which also comprises transmitting entity identity information generator 54. FIG. 5C illustrates a different situation in which one or more of the transmission and reception points (TRP) 60 may be remotely located with respect to processing part of access node 22C, but are situated so as to serve a same cell. By “remotely located” means that the transmission and reception points (TRP) 60 are geographically displaced from the geographical location of the access node. For example, in FIG. 5C the TRP 60J is distributive to another location 62 in the cell. The remote location 62 may be understood with reference to the situation of one or more of TRPs #1 through #3 in FIG. 2 for example. Each of the transmission and reception point (TRPs) such as TRP 601 and TRP 60J of FIG. 5C may be connected to the main portion of the access node 22C via any suitable means, such as by optical fiber or by radio connection, for example.

FIG. 5D illustrates an access node 22D which not only comprises plural TRPs 60, but in which one or more of the TRPs 60 may be associated with plural beams. For example, the TRP transceiver 32-1 of transmission and reception point (TRP) 60-1 comprises transmitter circuitry 34-1-1 configured to transmit a first beam, and transmitter circuitry 34-1-2 configured to transmit a second beam. The transmitting entity identity information transmitted through beam transmitter 34-1-1 of TRP 60-1, as generated by transmitting entity identity information generator 54, expresses the physical layer cell identifier (PCID) associated with the cell served by access node 22D, as well as the transmission and reception point identifier (TRP ID #1) associated with transmission and reception point (TRP) 60-1 and a beam identifier (BID) associated with the first beam transmitted by beam transmitter 34-1-1. The transmitting entity identity information transmitted through beam transmitter 34-1-2 of TRP 60-1, as generated by transmitting entity identity information generator 54, expresses the physical layer cell identifier (PCID) associated with the cell served by access node 22D, as well as the transmission and reception point identifier (TRP ID #1) associated with transmission and reception point (TRP) 60-1 and a beam identifier (BID) associated with the beam transmitted by beam transmitter 34-1-2.

Similarly, for example, the TRP transceiver 32-K of transmission and reception point (TRP) 60-K may comprise transmitter circuitry 34-K-1 configured to transmit a first beam, and transmitter circuitry 34-K-2 configured to transmit a second beam. The transmitting entity identity information transmitted through beam transmitter 34-K-1 of TRP 60-K, as generated by transmitting entity identity information generator 54, expresses the physical layer cell identifier (PCID) associated with the cell served by access node 22D, as well as the transmission and reception point identifier (TRP ID #K) associated with transmission and reception point (TRP) 60-K and a beam identifier (BID) associated with the first beam transmitted by beam transmitter 34-K-1. The transmitting entity identity information transmitted through beam transmitter 34-K-2 of TRP 60-1, as generated by transmitting entity identity information generator 54, expresses the physical layer cell identifier (PCID) associated with the cell served by access node 22D, as well as the transmission and reception point identifier (TRP ID #K) associated with transmission and reception point (TRP) 60-K and a beam identifier (BID) associated with the beam transmitted by beam transmitter 34-K-2. It should be understood that not all of the TRPs need to have plural beams, and that for the TRPs that have plural beams, different numbers of plural beams may be associated with different TRPs (such plural numbering may include more than two beams for at least some TRPs).

FIG. 5E illustrates an access node 22E which does not comprises plural ports, but in which the transmitter 34E is associated with plural beams. For example, the station transmitter 34E of access node 22E comprises transmitter circuitry 34E-1 configured to transmit a first beam, and transmitter circuitry 34E-2 configured to transmit a second beam. The transmitting entity identity information transmitted through beam transmitter 34E-1 of access node 22E, as generated by transmitting entity identity information generator 54, expresses the physical layer cell identifier (PCID) associated with the cell served by access node 22E, as well as beam identifier (BID) associated with the first beam transmitted by beam transmitter 34E-1. The transmitting entity identity information transmitted through beam transmitter 34E-2 of access node 22E, as generated by transmitting entity identity information generator 54, expresses the physical layer cell identifier (PCID) associated with the cell served by access node 22E, as well as beam identifier (BID) associated with the second beam transmitted by beam transmitter 34E-2.

Techniques and methods are hereinafter described for explaining various example ways in which the transmitting entity identity information may be configured to express the plural types of transmission identifiers, e.g., the physical layer cell identifier (PCID), transmission and reception point identifier (TRP ID), and the beam identifier (BID). Hereinafter, unless otherwise noted, reference to “access node 22” should be understood to refer to or include any of the access nodes 22A-22E depicted in FIG. 5A-FIG. 5F, respectively.

In an example, non-limiting embodiments and modes, transmitting entity identity information may be structured so that a first pair of PSS and SSS in a first SS block may provide a first identifier (e.g., PCID), a second pair of PSS and SSS in a second SS block may provide a second identifier (TRP ID); and a third pair of PSS and SSS in a third SS block may provide a third identifier (Beam ID). In other words, in some non-limiting example embodiments and modes, the transmitting entity identity information may be generated over time, e.g., over differing SS blocks, such that at a first time instance or first SS block the transmitting entity identity information generator 54 may generate a portion of the transmitting entity identity information that pertains to a first type of transmitting identifier (e.g., physical layer cell identifier (PCID)); that at a second time instance or second SS block the transmitting entity identity information generator 54 may generate another portion of the transmitting entity identity information that pertains to another type of transmitting identifier (e.g., the transmission and reception point identifier (TRP ID) for the case of FIG. 2B-FIG. 2D or the beam identifier (BID) for the case of FIG. 2E); and that that at a third time instance or third SS block the transmitting entity identity information generator 54 may generate another portion of the transmitting entity identity information that pertains to yet another type of transmitting identifier (e.g., the beam identifier (BID) for the case of FIG. 2D).

In other example embodiment and modes, however, the same PSS carrying the same information may be repeated in different SS blocks, as this PSS may have its own periodicity to transmit the same content.

Moreover, the terminology “TRP” is used below for any NR base station (although it should be understood that one NR base station may have multiple TRP); “TRP” as used herein could also mean “eNB”, or “gNB” which is currently defined in 3GPP for NR base station, or some other terminologies representing similar meaning. Also, as used herein, mention to terminologies such as PSS/SSS/PBCH and other signals, channels, mean the corresponding synchronization signals, broadcast channels, other signals, channels applicable to both LTE and future generation (e.g., 5G or NR) systems.

As explained above, three types of identifiers (IDSs) included for consideration may be the following:
(1) Cell ID Or PCI ID (which have same meaning herein)
   In some LTE systems, the PCI ID number is 168*3=504; which can meet the requirements of LTE system network planning. On the other hand, in future systems such as 5G or NR systems, for example, there may be other alternatives. One alternative is for the future or NR system to also require 504 PCI IDs. But another alternative s for the future or NR system to require more than 504 PCI IDs. More PCI IDs may be needed because, for example, the distance between cells may be smaller. The more required IDs are for the purpose of original meaning—physical layer cell ID, which means the NR system practically needs more cell ID for network planning.
(2) TRP ID
   As understood from the foregoing, the TRP ID may be an independent type of ID, or some type of ID associated with a gNB antenna port. For example, the TRP ID could be a virtual type of identifier.
(3) Beam ID
   The foregoing are non-limiting examples of the three types of identifiers that can be expressed by the transmitting entity identity information. Other types of identifiers could instead be expressed, including but not limited to identifiers that have some type of hierarchical structure or relationship. The other types of identifiers could be progressively discrete with respect to identifying structure or functionality of the access node.

Any combinations of the above one, or two, or three types of IDs, or even other types of identifiers, may be provided by the network and detected by the UE or informed to the UE by the network. As used herein, the transmitting entity identity information generated by the transmitting entity identity information generator 54 expresses one or more of plural types of transmitter identifiers, such as (for example) the physical layer cell identifier (PCID), transmission and reception point identifier (TRP ID), and beam identifier (BID) described above. In this regard, it is possible for the transmitting entity identity information to encompass the combinations of (1) & (2), or (1) & (3), or (1) & (2) & (3), and may be called as one name, e.g., PCI ID, only.

FIG. 9 is a diagrammatic view showing example embodiments and modes of alternative identification assignment techniques. For any of the example embodiments and modes described herein, such as the example embodiments and modes of FIG. 5A-FIG. 5F, for example, any one of various methods or techniques illustrated in FIG. 9 and/or described herein or encompassed hereby may be used for the network to assign the IDs and thus configure the transmitting entity identity information. The techniques disclosed herein may be used in conjunction with the SS block structure described above. It should be understood, for example, that technique alternative A may be used with one or more of the example embodiments and modes of FIG. 5A-FIG. 5F, and is not restrictively paired with the example embodiment and mode having the “A” suffix, and likewise for other technique alternatives

ID Assignment Technique Alternative A

The transmitting entity identity information assignment technique of Alternative A uses NR-SSS, e.g., new radio (NR) secondary synchronization sequences (SSS). As the detection of NR-PSS is non-coherent with high detection complexity, in Alternative A for fast timing acquisition, only one NR-PSS is provided, so no ID information is carried by NR-PSS. The NR-PSS may be used for timing information or other information other than ID information. But the ID information (i.e., the transmitting entity identity information) is provided by NR-SSS. That is, the transmitting entity identity information generator 54 is arranged to express the transmitting entity identity information using secondary synchronization sequences with no primary synchronization sequences (PSS) being used to express the transmitting entity identity information.

ID Assignment Technique Alternative B

The transmitting entity identity information assignment technique of Alternative B uses both NR-PSS and NR-SSS to express the transmitting entity identity information, i.e., uses both new radio primary synchronization sequences (PSS) and new radio secondary synchronization sequences (SSS). That is, the transmitting entity identity information generator 54 is arranged to express the transmitting entity identity information using a combination of primary synchronization sequences and secondary synchronization sequences. There are at least four sub-alternatives, e.g., Alternatives B.1 through B.4 for Alternative B. FIG. 10-1 through FIG. 10-4 are diagrammatic views illustrating example, non-limiting implementations of ID assignment techniques B.1 through B.4, respectively.

ID Assignment Technique Alternative B.1

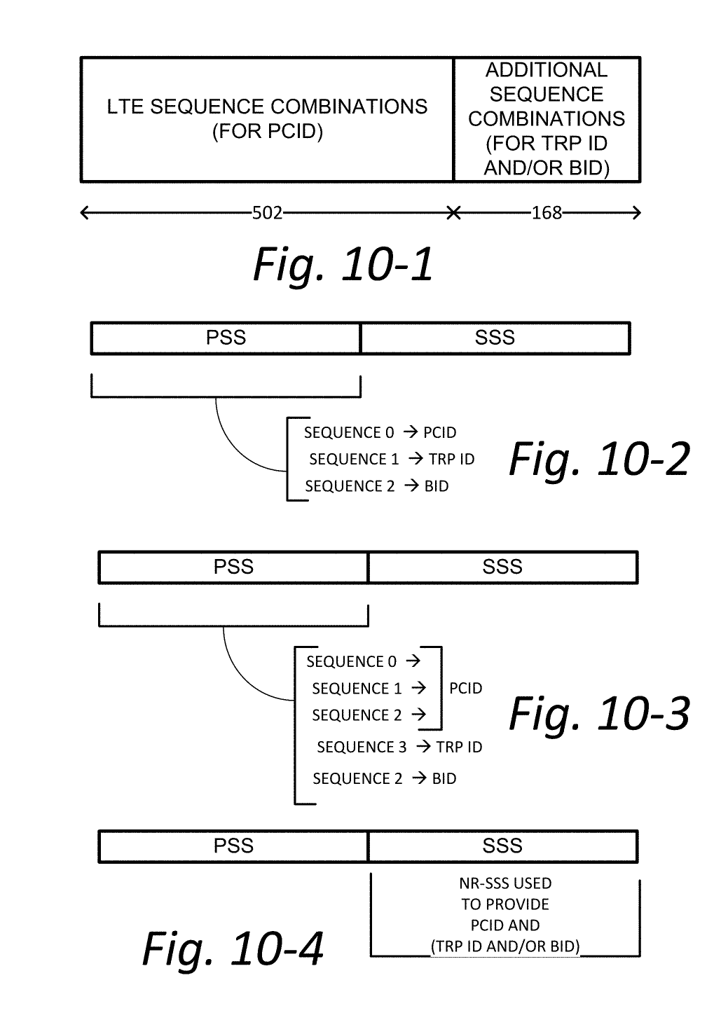

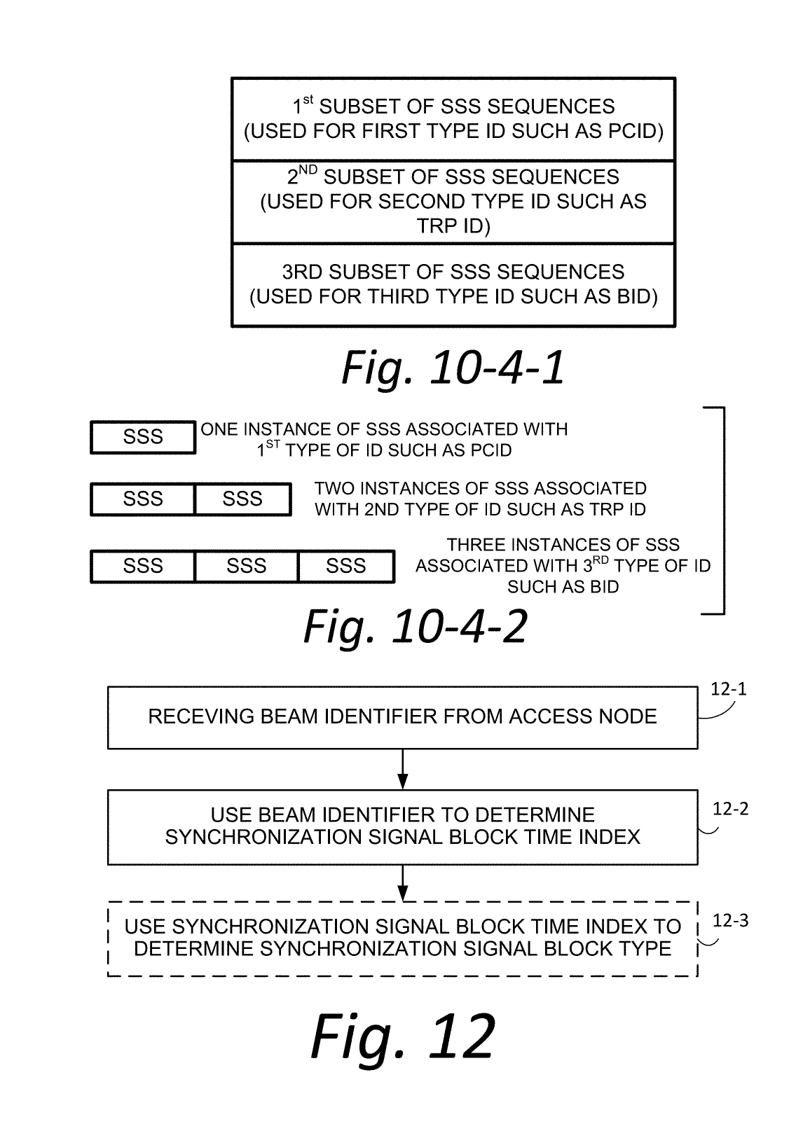

The transmitting entity identity information assignment technique of Alternative B.1 uses, e.g., X number of PSS sequences to provide identification of cell ID (0-(X-1)); and SSS sequences to provide identification of cell ID group (0-Y), where, X is an integer not greater than 3; wherein Y=168*Z, and wherein Z is an integer equal or greater than 1. In so doing, the PSS complexity is limited by virtue of X being not greater than 3 (so that only a limited number of PSS candidate sequences need be tried) but still provides relative high detection capacity. Once the cell identity is captured using PSS, the transmitting entity identity information generator 54 has more SSS sequence combinations available beyond the (Z=1) situation of LTE. In LTE there are 504 sequence combinations. But if X is limited (e.g., X=2) and if Z=2, then there are 168*2=336 SSS sequence combinations, with a total number of combinations being 2*336=672, which is more than the original 504 number of combinations for LTE. Thus, the transmitter entity identity information generator 54 may have a greater number of sequence combinations to carry the transmitter entity identity information, with the additional sequences being available to express one or more of transmission and reception point identifiers (TRP IDs) and/or beam identifiers (BIDs). That is, as illustrated by way of example in FIG. 10-1, the additional sequence combinations could be for any combination of one, or two, or three types of ID: for example, 168 sequence combinations could be all for extra required cell ID, or TRP ID, or beam ID, or cell ID & TRP ID, or cell ID & beam ID, or beam ID & TRP ID, or all of them. Moreover, in a future radio system such as new radio (NR) 672 sequences may be totally rearranged without considering the limitation of 504, so the 672 sequence combinations may be used for cell ID, or TRP ID, or beam ID, or cell ID & TRP ID, or cell ID & beam ID, or beam ID & TRP ID, or all of them.

ID Assignment Technique Alternative B.2

The transmitting entity identity information assignment technique of Alternative B.2 is similar to the technique of Alternative B.1, but a difference is that PSS sequences carry information to distinguish different types of IDs. For example, if there are 3 PSS sequences, one/first PSS is used to identify the cell ID (e.g., physical layer cell identifier (PCID)); another/second PSS is used to identify TRP ID (transmission and reception point identifier (TRP ID), and yet another/third PSS is used to identify the beam ID (beam identifier (BID)). See, for example, the non-limiting implementation of Alternative B.2 illustrated in FIG. 10-2. Mention of three number of PSS is merely an example, as there may be M integer number of M integer number of different ID types.

Thus, in an example implementation of the technique of Alternative B.2 the transmitting entity identity information generator 54 is arranged to use M integer number of plural types of transmission identifiers, and wherein the processor circuitry is further arranged to express an M^{th} type identifier using a corresponding M^{th} first primary synchronization sequence.

Moreover, in an example implementation of the technique of Alternative B.2 the transmitting entity identity information generator 54 is arranged to configure a primary synchronization sequence comprising the transmitting entity identity information to indicate one type of the plural types of transmission identifiers. In this example implementation the transmitting entity identity information generator 54 may be further arranged to configure a secondary synchronization sequence to indicate a particular transmitting agent of the indicated one type, e.g., a transmission and reception point identifier (TRP ID) for a particular transmission and reception point (TRP) or a beam identifier (BID) for a particular beam transmitter.

ID Assignment Technique Alternative B.3

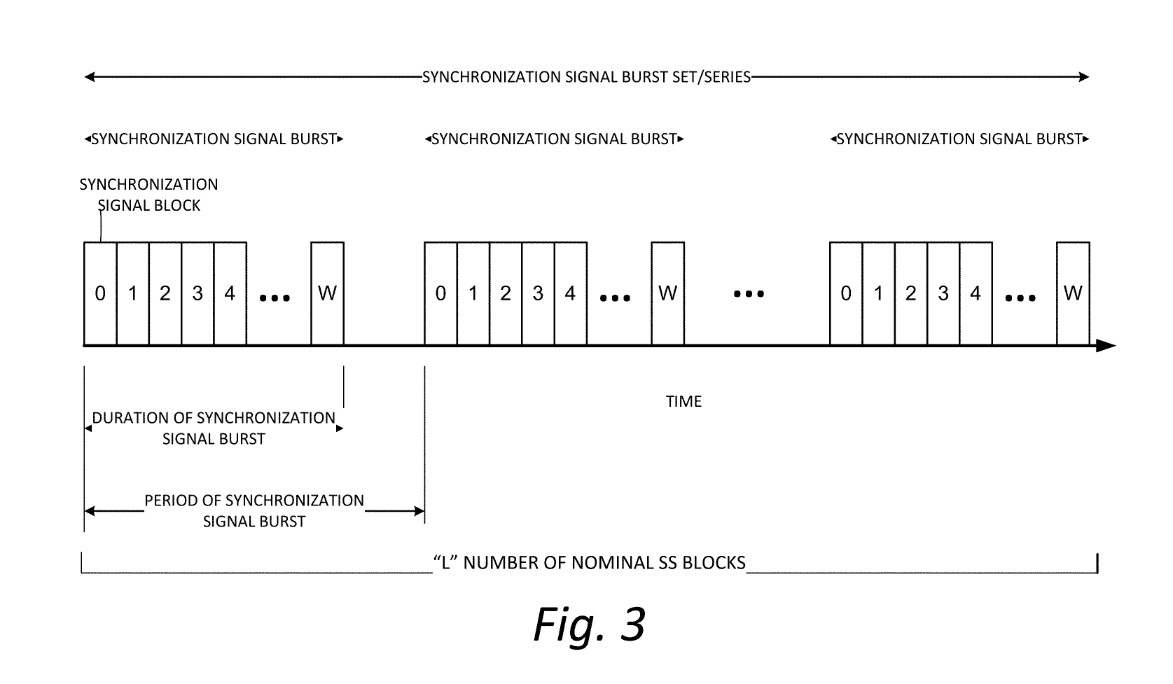

The transmitting entity identity information assignment technique of Alternative B.3 comprises a combination of the technique of Alternative B.1 and the technique of Alternative B.2. In this technique of Alternative B.3 some of the PSS sequences provide cell ID identification; and some of the PSS sequences provide other types of IDs. For example, if there are five PSS sequences, the first three PSS sequences (0, 1, and 2) may indicate cell ID. But if a fourth PSS sequence is detected, the fourth PSS sequence may pertain to beam ID or TRP ID. See, for example, the non-limiting implementation of Alternative B.3 illustrated in FIG. 10-3. Therefore, Alternative B.3 comprises a combination of the technique of Alternative B.1 and the technique of Alternative B.2.

ID Assignment Technique Alternative B.4

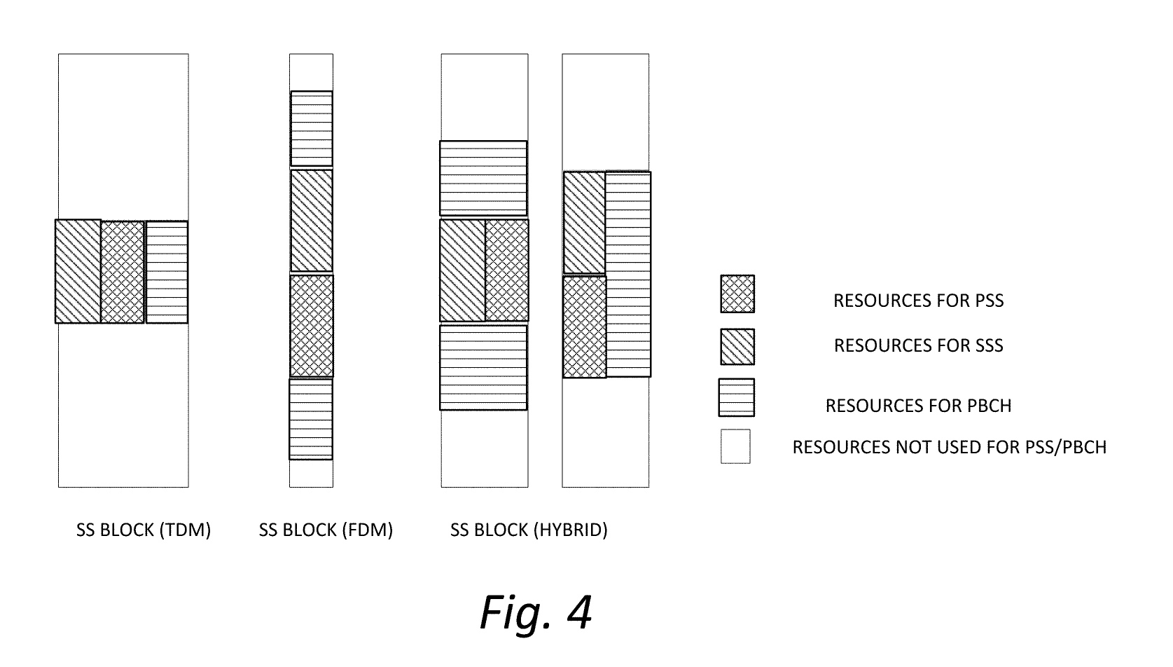

The transmitting entity identity information assignment technique of Alternative B.4 is similar to the technique of Alternative B.1, but a difference is that in Alternative B.4 the NR-SSS is used to provide not only cell ID group information, but also other types of ID information. That is, the transmitting entity identity information generator 54 is arranged to configure the transmitting entity identity information to comprise a secondary synchronization sequence which provides both a physical layer cell identifier (PCID) and another one of the plural types of transmitter identifiers. See, for example, the non-limiting implementation of Alternative B.4 illustrated in FIG. 10-4. Alternative B.4 may comprises several sub-alternative cases, two of which are discussed below by way of example, as illustrated by way of example implementations in FIG. 10-4-1 and FIG. 10-4-2.

ID Assignment Technique Alternative B.4.1

The transmitting entity identity information assignment technique of Alternative B.4.1 uses longer NR-SSS sequences (compared to SSS sequences for some LTE systems) so more NR-SSS sequence candidates are provided. Different NR-SSS sequences may be used to indicate different types of ID information. So the set of SSS can be partitioned to express more information. For example, SSS sequences numbered from 0 to ⅓ the max SSS number can carry a first type identifier; SSS sequences numbered from ⅓+1 of the max SSS number to ⅔ the max SSS number can carry a first type identifier; and SSS sequences numbered from ⅔+1 of the max SSS number to the max SSS number can carry a third type identifier. See, for example, the non-limiting implementation of Alternative B.4.1 illustrated in FIG. 10-4-1. This is one partitioning method, there are some other partitioning methods such as changing partitioning points other than ⅓, ⅔, or less than three types of IDs need to be delivered, then less partitioning points are needed.

ID Assignment Technique Alternative B.4.2

For the transmitting entity identity information assignment technique of Alternative B.4.2 the length of the SSS sequences is not of concern, and in fact could be the same length as SSS sequences of other LTE systems. For the transmitting entity identity information assignment technique of Alternative B.4.2 the repetition number of NR-SSS sequences (either in time domain repetition, or frequency domain repetition, or both) may be used to indicate different types of IDs. For example, if there is no repetition of the SSS sequence, the lack of repetition may indicate a first type of transmitting entity ID (e.g., PCID). But the SSS may be so structured so that there can be and are two repetitions of the SSS sequence. A second SSS or a repetition(s) of the SSS may constitute or comprise a tertiary synchronization signal (TSS). Then detection of two repetitions of the SSS sequence, or detection of SSS and TSS, may indicate a second type of transmitter ID (e.g., TRP ID. Moreover, if the SSS is so structured so that there can be and are three repetitions of the SSS sequence, then detection of three repetitions of the SSS sequence may indicate a third type of transmitter ID (e.g., beam ID). See, for example, the non-limiting implementation of Alternative B.4.2 illustrated in FIG. 10-4-2.

In the alternative B.4.2., the subcarrier spacing of NR-SSS may be different from subcarrier spacing of NR-PSS. There is one special case in this alternative B.4.2: the subcarrier spacing is predefined to carry different types of ID information, e.g., 15 KHz subcarrier spacing for NR-SSS means it only carries one type of ID information; 30 KHz for NR-SSS means it can carry two types of ID information. Numbers such as 15 KHz and 30 KHz are given examples; as it should be understood that other numbers could instead be used.

Thus, in an example implementation of Alternative B.4.2, transmitting entity identity information generator 54 is arranged to configure the transmitting entity identity information whereby a number of repetitions of a particular secondary synchronization sequence indicates a particular type of the plural types of identifiers associated with the access node. For example, the transmitting entity identity information generator 54 may configure the transmitting entity identity information to comprise a number of repetitions of a particular secondary synchronization sequence in a time domain and by such number of repetitions indicate a particular type of transmitter identifier (e.g., one of physical layer cell identifier (PCID), transmission and reception point identifier (TRP ID), or beam identifier (BID)). Alternatively, as another example implementation, the transmitting entity identity information generator 54 is arranged to configure the transmitting entity identity information to comprise a number of repetitions of a particular secondary synchronization sequence in a frequency domain and by such number of repetitions indicate a particular type of transmitter identifier (e.g., one of physical layer cell identifier (PCID), transmission and reception point identifier (TRP ID), or beam identifier (BID)).

Thus, in an example implementation of Alternative B.4.2, transmitting entity identity information generator 54 is arranged to configure the transmitting entity identity information whereby subcarrier spacing for the secondary synchronization sequences indicates a number of the plural types of transmission identifiers expressed by the transmitting entity identity information.

ID Assignment Technique Alternative C

The transmitting entity identity information assignment technique of Alternative C uses broadcast information to transmit the transmitting entity identity information. In Alternative C any combinations of the above one, or two, or thee IDs are delivered by broadcast information. In a new radio (NR) or future generation system, there may be two types of broadcast information: one is essential system information, and the other is on demand system information. In an on demand system the “demanded” system information is delivered to the UE upon the UE's request. Such ID information (e.g., one or more of physical layer cell identifier (PCID), transmission and reception point identifier (TRP ID), and beam identifier (BID)) can be carried by either essential system information, or on demand system information if UE need this information, or both.

ID Assignment Technique Alternative D

The transmitting entity identity information assignment technique of Alternative D uses dedicated signaling information to transit the transmitting entity identity information. In Alternative C any combinations of the above one, or two, or thee IDs are delivered by dedicated signaling information from network.

The way for the network to assign IDs could be the combination of any one, or two, or three, or four of the above-mentioned alternatives.

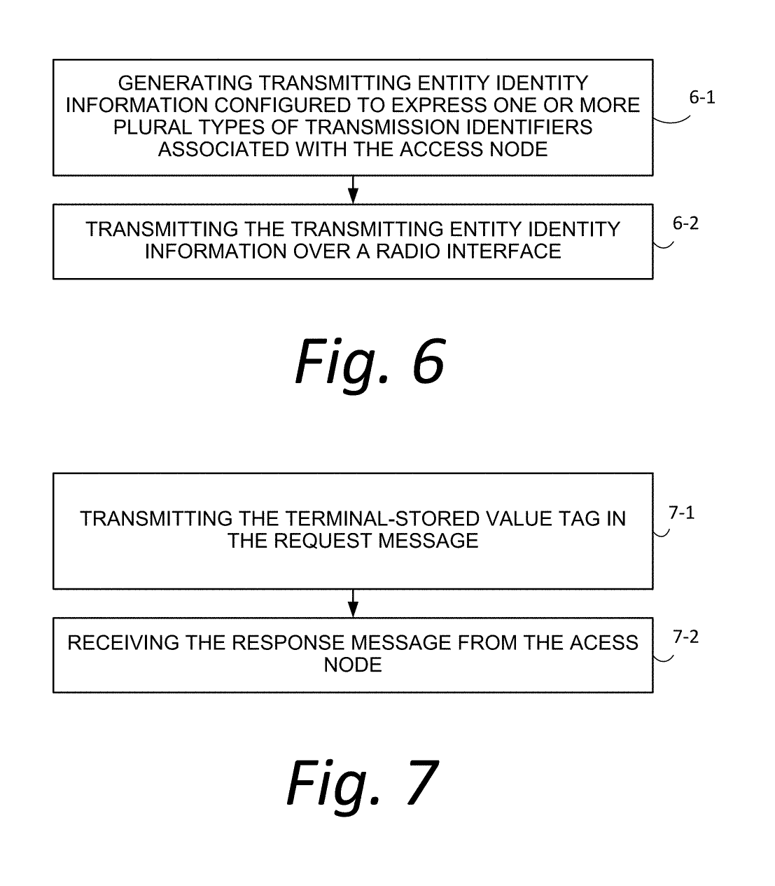

FIG. 6 shows example, non-limiting, representative acts or steps performed by the access node of any one of the example embodiments and modes of FIG. 5A-FIG. 5F. Act 6-1 comprises using processor circuitry (e.g., transmitting entity identity information generator 54) to generate transmitting entity identity information configured to express one or more plural types of transmission identifiers. The transmitting entity identity information may be generated in accordance with one or more of the example embodiments and modes/alternative techniques described above. Act 6-2 comprises the access node transmitting the transmitting entity identify information over a radio interface, e.g., radio interface 24, where it may be received by a wireless terminal, e.g., UE.

From FIG. 5A it should be understood that any of the wireless terminals (UEs) of any of the example embodiments and modes described herein, including but not limited to those of FIG. 5A-FIG. 5F, receive the transmitting entity identity information over the radio interface 24 using receiver circuitry 46. The inclusion of the transmitting entity identity information in received information is discerned by terminal frame/signal handler 52, which passes the transmitting entity identity information to identity processor 56. The identity processor 56 is configured and arranged to decode or determine the content/sequences of the transmitting entity identity information, and thus one or more of the physical layer cell identifier (PCID), the transmission and reception point identifier (TRP ID), and the beam identifier (BID) in accordance with logic or convention agreed with the transmitting entity identity information generator 54 of the respective access node. That is, the identity processor 56 is configured to utilize an appropriate one or more of the ID assignment technique alternatives described above in order to glean the one or more transmitter identifiers which is expressed by the transmitting entity identity information.

FIG. 7 shows example, non-limiting, representative acts or steps performed by a wireless terminal of any one of the example embodiments and modes of FIG. 5A-FIG. 5E. Act 7-1 comprises receiving transmitting entity identify information over a radio interface. Act 7-2 comprises using processor circuitry (e.g., identity processor 56) to determine, from the transmitting entity identity information, one or more plural types of transmission identifiers associated, e.g., one or more of physical layer cell identifier (PCID), transmission and reception point identifier (TRP ID), and beam identifier (BID).

Thus, it has been described above how the technology disclosed herein provides methods, apparatus, and techniques for one or more of flexible and systematic NR synchronization signal design; flexibly hierarchical IDs for 5G system, in view of a system such as 5G system requiring more IDs for UEs to recognize and access network. It has been shown how, in one of its aspects, the technology disclosed herein particularly provides capability for expressing a greater number of identifiers associated with a network node, such as one or more of physical layer cell identifier (PCID), transmission and reception point identifier (TRP ID), and beam identifier (BID).

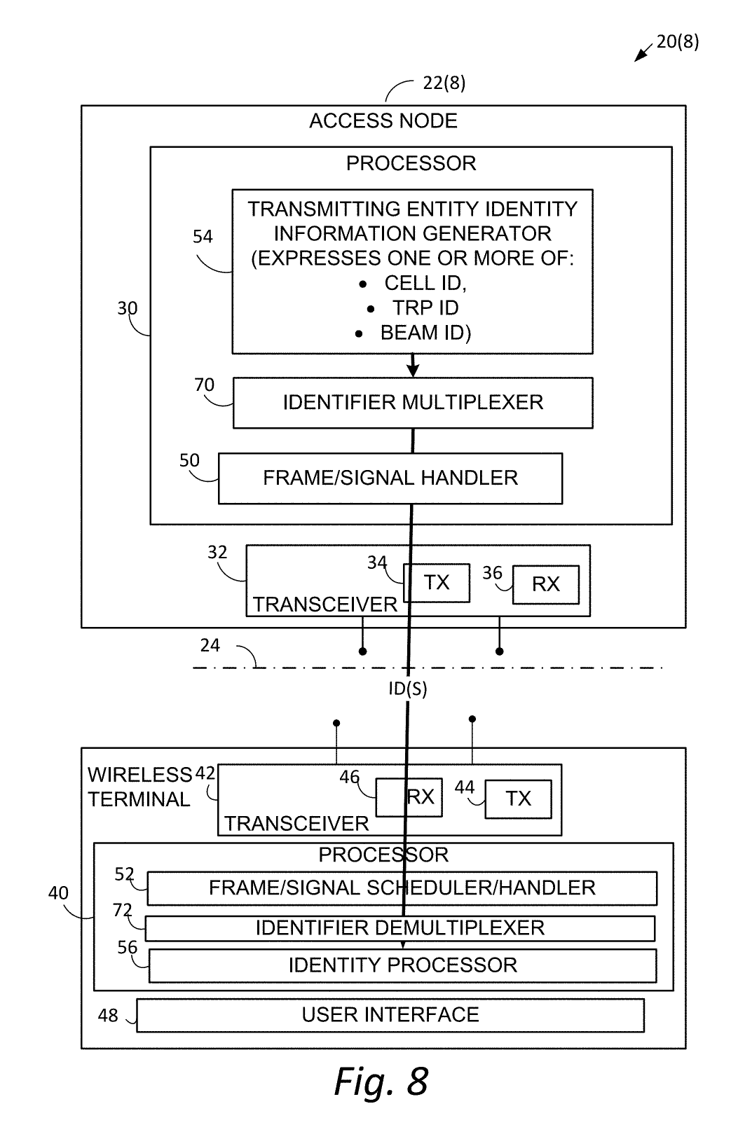

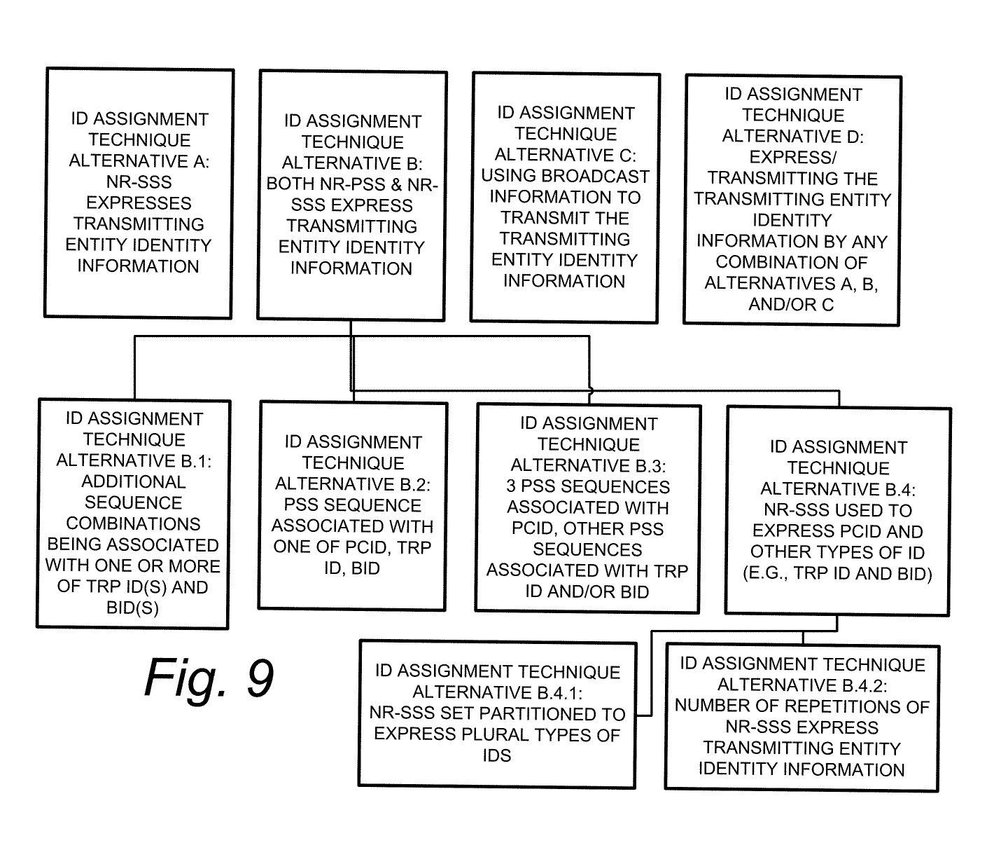

It was mentioned above, e.g., with reference to FIG. 4, that because different information, e.g., sync signals, or PBCH, or reference signals may have different periodicity, or some of them are upon request, or for other reasons, not all of such information may always be in every SS block. In accordance with another aspect of the technology disclosed herein, multiplexing techniques are provided in conjunction with the transmission of such information (e.g., signals, or PBCH, or reference signals). FIG. 8 shows how an access node, such as any one of the access nodes of FIG. 5A-FIG. 5F or another other access node, may be configured to multiplex transmitting entity identity information into SS blocks. In particular, FIG. 8 shows the access node 22(8) as comprising identifier multiplexer 70. Identifier multiplexer 70 controls multiplexing of transmitting entity identity information or other such transmitter identification information into one or more SS blocks. The transmitting entity identity information as multiplexed in to the SS blocks is transmitted over the air interface and received by the wireless terminal. FIG. 8 further shows that the wireless terminal comprises identity de-multiplexer 72 which is configured to de-multiplex the transmitting entity identity information from the received SS blocks. Described below are various example multiplexing and de-multiplexing techniques that may be implemented, e.g., by identifier multiplexer 70.

Multiplexing Technique Alternative I

In multiplexing technique I, resources (time and/or frequency resources) in the SS block are reserved for particular purposes, e.g., some are reserved for sync signals, some are for PBCH, and some are for reference signals. Alternative I thus does not necessarily use all resources if corresponding information is not presented in the SS block.

Multiplexing Technique Alternative II

In multiplexing technique II, if some information is absent in some SS block, from the network side, other information can further occupy those resources to do repetition for better detection/decoding performance. From the UE side, the UE assumes the periodicity of different elements in the SS block, so UE assumes a priori in some SS block, some information are repeated more times than in other SS block.

Use of Beam ID to Determine Synchronization Signal Block Time Index

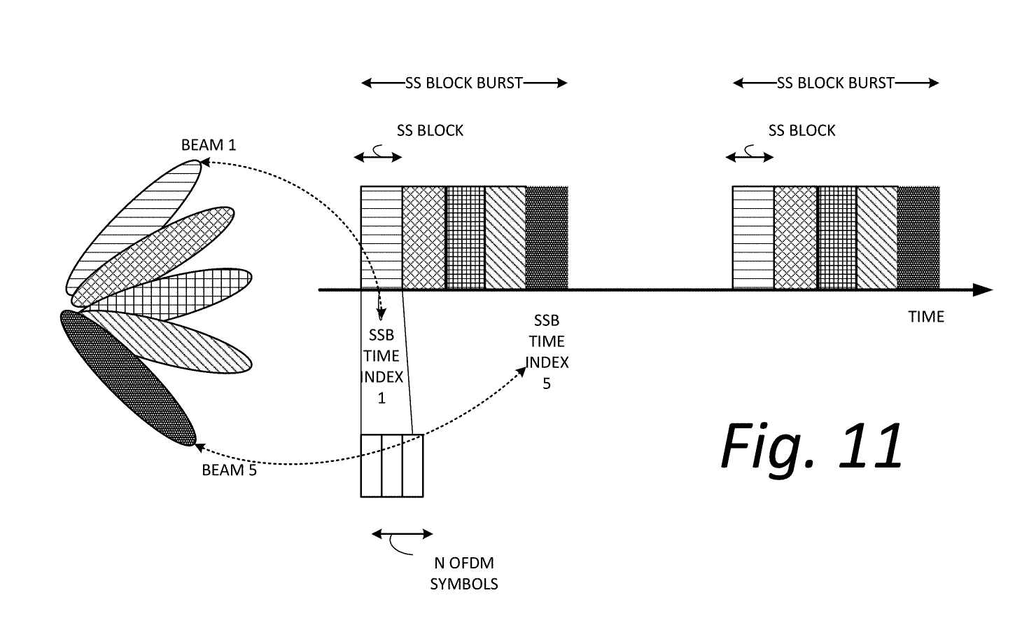

In another example embodiment and mode, the synchronization signal blocks generated by the access node 22 are beam-based. FIG. 11 shows synchronization signal block burst set 80, comprising synchronization signal block bursts 82₁ and 82₂. Each synchronization signal block burst 82 comprises plural synchronization signal blocks, each of the synchronization signal blocks having a different synchronization signal block time index. Each of the synchronization signal blocks, and thus each of the synchronization signal block time indexes associated with the respective synchronization signal blocks, is paired or associated with a unique one of plural beams transmitted by the access node.

FIG. 5F shows access node 22F as comprising a system information (SI) generator 54 in the manner of, for example, FIG. 5D, which generates an identity that expresses, e.g., beam ID (beam identifier (BID). FIG. 5F further shows that the terminal processor 40 of wireless terminal 26F comprises a synchronization signal block detector 88 that determines a synchronization signal block time index from the beam ID that is received from the access node 26F.

FIG. 12 shows example, basic acts or steps performed by the wireless terminal 26F of FIG. 5F. Act 12-1 comprises the wireless terminal receiving a beam identifier (BID) over radio interface 24 from access node 22F. The beam ID (beam identifier (BID) may be obtained in any of the manners described above and/or encompassed hereby. After the wireless terminal 26F has determined the beam identifier (BID) by such techniques, the synchronization signal block detector 88 uses the beam identifier (BID) to derive a synchronization signal block time index for a synchronization signal block that is associated with the beam identifier (BID). For example, the beam identifier (BID) may be equated to the synchronization signal block time index, or mathematically used to derive the synchronization signal block time index, or used as an index into a mapping table or the like to ascertain the synchronization signal block time index. Further, as optional act 12-3, the terminal processor 40 may use the synchronization signal block time index to determine a synchronization signal block type for a received synchronization signal block. The significance of synchronization signal block time index, and other ways of determining synchronization signal block time index, are described in U.S. provisional Patent application 62/454,016 (attorney docket: SLA3718P 6112-69), filed Feb. 2, 2017, entitled “SYNCHRONIZATION SIGNAL TRANSMISSION AND RECEPTION FOR RADIO SYSTEM”, which is incorporated herein by reference in its entirety.

In the above regard, for example, based on the index (indices) of the synchronization signal block, the synchronization signal burst, and/or the synchronization signal burst set, the wireless terminal may derive (identify, recognize), a symbol(s), and/or a slot index in a radio frame. For example, one index may be defined (e.g., indicated, configured) for every synchronization signal block within one synchronization signal burst, and/or one synchronization signal burst set. Also, one index that is specific to each synchronization signal block may be defined within one synchronization signal burst, and/or one synchronization signal burst set. Also, one index of synchronization signal burst that is specific to each synchronization signal burst may be defined within one synchronization signal burst set. Also, the index (indices) of synchronization signal burst, and/or synchronization signal burst set may be common across synchronization signal blocks in each synchronization signal burst, and/or each synchronization signal burst set.

Moreover, the index (indices) of the synchronization signal block may be indicated (identified, configured) by using primary synchronization signal (PSS), secondary synchronization signal (SSS), tertiary synchronization signal (TSS), and/or PBCH. For example, the index (indices) of the synchronization signal block may be implicitly, and/or explicitly indicated by using PBCH. Also, the wireless terminal may assume a synchronization signal block (e.g., a given synchronization signal block) is repeated with a periodicity of synchronization signal burst. Also, the wireless terminal may assume a synchronization signal block (e.g., a given synchronization signal block) is repeated with a periodicity of synchronization signal burst set. Here, the periodicity of synchronization signal burst, and/or the periodicity of synchronization signal burst set may predefined with a default fixed value, or may be configured by the access node (e.g., the base station apparatus).

There may be two alternative example embodiments and modes for SS-block index. In a first example embodiment and mode, time index may be counted within one SS burst set (in which case, no SS burst concept is defined). In a second example embodiment and mode, the time index may be counted within SS burst. As used herein, beam identifier (BID) may be according to either of these alternative example embodiments and modes, e.g., beam ID allocation (from network side) is either per SS burst, or per SS burst set.

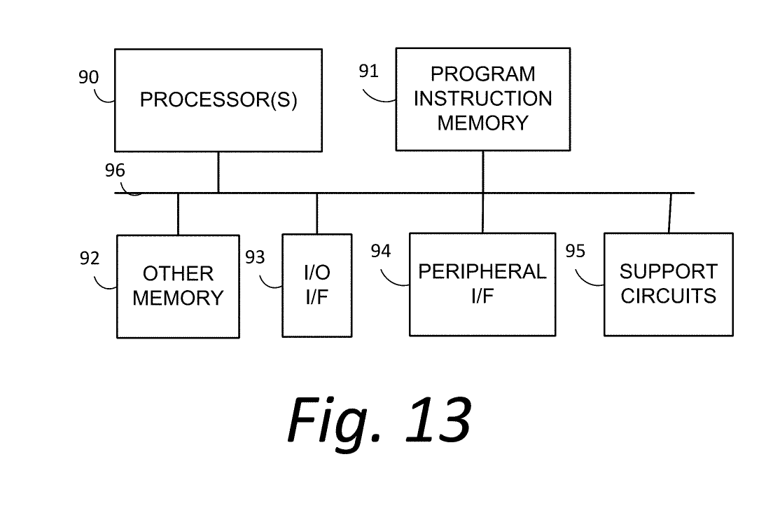

Certain units and functionalities of node 22 and wireless terminal 26 are, in example embodiments, implemented by electronic machinery, computer, and/or circuitry. For example, the node processors 30 and terminal processors 40 of the example embodiments herein described and/or encompassed may be comprised by the computer circuitry of FIG. 13. FIG. 13 shows an example of such electronic machinery or circuitry, whether node or terminal, as comprising one or more processor(s) circuits 90, program instruction memory 91; other memory 92 (e.g., RAM, cache, etc.); input/output interfaces 93; peripheral interfaces 94; support circuits 95; and busses 96 for communication between the aforementioned units.

The program instruction memory 91 may comprise coded instructions which, when executed by the processor(s), perform acts including but not limited to those described herein. Thus is understood that each of node processor 30 and terminal processor 40, for example, comprise memory in which non-transient instructions are stored for execution.

In the above regard, the access node 22 of any of the example embodiments and modes described herein may comprise at least one processor (e.g., processor 30/90); at least one memory (e.g., memory 91) including computer program code, the memory and the computer program code configured to, working with the at least one processor, to cause the access node to perform the acts described herein, such as the acts of FIG. 6, for example. Similarly the wireless terminal 26 of any of the example embodiments and modes described herein may comprise at least one processor (e.g., processor 40/90); at least one memory (e.g., memory 91) including computer program code, the memory and the computer program code configured to, working with the at least one processor, to cause the wireless terminal 26 to perform the acts described herein, such as the acts of FIG. 7, for example.

The memory, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 95 may be coupled to the processors 90 for supporting the processor in a conventional manner. These circuits include cache, power supplies, clock circuits, input/output circuitry and subsystems, and the like.

Although the processes and methods of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture. The instructions of such software are stored on non-transient computer readable media.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

It will be appreciated that the technology disclosed herein is directed to solving radio communications-centric issues and is necessarily rooted in computer technology and overcomes problems specifically arising in radio communications. Moreover, in at least one of its aspects the technology disclosed herein improves the functioning of the basic function of a wireless terminal and/or node itself so that, for example, the wireless terminal and/or node can operate more effectively by prudent use of radio resources.

Example embodiment and modes of the technology encompass but are not limited to the following:

### EXAMPLE EMBODIMENT 1

An access node comprising:

processor circuitry arranged to generate transmitting entity identity information configured to express one or more plural types of transmission identifiers;

a transmitter configured to transmit the transmitting entity identify information over a radio interface.

### EXAMPLE EMBODIMENT 2

The access node of example embodiment 1, wherein the plural types of transmission identifiers comprise a physical layer cell identifier (PCID) and one or more of a transmission and reception point identifier (TRP ID) and a beam identifier (BID).

### EXAMPLE EMBODIMENT 3

The access node of example embodiment 1, wherein the transmitting entity identity information is carried in plural synchronization signal blocks, and wherein different ones of the plural synchronization blocks carry different ones of the plural types of transmission identifiers.

### EXAMPLE EMBODIMENT 4

The access node of example embodiment 1, wherein the processor circuitry is arranged to express the transmitting entity identity information using secondary synchronization sequences.

### EXAMPLE EMBODIMENT 5

The access node of example embodiment 1, wherein the processor circuitry is arranged to express the transmitting entity identity information using a combination of primary synchronization sequences and secondary synchronization sequences.

### EXAMPLE EMBODIMENT 6

The access node of example embodiment 5, wherein the processor circuitry is arranged to use one of X integer number of primary synchronization sequences, X not greater than 3, and one of Y integer number of secondary synchronization sequences, wherein Y=168*Z, Z being an integer equal or greater than 1, and thereby provide additional sequence combinations beyond 504 physical layer cell identifier (PCID) sequence combinations, the additional sequence combinations being associated with one or more of transmission and reception point identifiers (TRP IDs) and/or beam identifiers (BIDs).

### EXAMPLE EMBODIMENT 7

The access node of example embodiment 5, wherein the processor circuitry is arranged to configure a primary synchronization sequence comprising the transmitting entity identity information to indicate one type of the plural types of transmission identifiers.

### EXAMPLE EMBODIMENT 8

The access node of example embodiment 7, wherein the processor circuitry is arranged to configure the secondary synchronization sequence to indicate a particular transmitting agent of the indicated one type.

### EXAMPLE EMBODIMENT 9

The access node of example embodiment 7, wherein the processor circuitry is arranged to configure the transmitting entity identity information to comprise a first primary synchronization sequence to indicate a first of the plural types of transmission identifiers associated and to configure the transmitting entity identity information to comprise a second primary synchronization sequence to indicate a second of the plural types of transmission identifiers.

### EXAMPLE EMBODIMENT 10

The access node of example embodiment 7, wherein the processor circuitry is arranged to use M integer number of plural types of transmission identifiers, and wherein the processor circuitry is further arranged to express an Mth type identifier using a corresponding Mth first primary synchronization sequence.

### EXAMPLE EMBODIMENT 11

The access node of example embodiment 5, wherein the processor circuitry is arranged to configure the transmitting entity identity information to comprise a primary synchronization sequence from a first set of primary synchronization sequences to indicate a physical layer cell identifier (PCID) and another primary synchronization sequence from a second set of primary synchronization sequences to indicate another type of the plural types of transmission identifiers.

### EXAMPLE EMBODIMENT 12

The access node of example embodiment 1, wherein the processor circuitry is arranged to configure the transmitting entity identity information to comprise a secondary synchronization sequence to provide both a physical layer cell identifier (PCID) and another one of the plural types of transmitter identifiers.

### EXAMPLE EMBODIMENT 13

The access node of example embodiment 12, wherein the processor circuitry is arranged to selectively configure the transmitting entity identity information to comprise a secondary synchronization sequence belonging to a first set of secondary synchronization sequences to indicate a first type of the plural types of identifiers or to configure the transmitting entity identity information to comprise a secondary synchronization sequence belonging to a second set of secondary synchronization sequences to indicate a second type of the plural types of identifiers.

### EXAMPLE EMBODIMENT 14

The access node of example embodiment 5, wherein the processor circuitry is arranged to configure the transmitting entity identity information whereby a number of repetitions of a particular secondary synchronization sequence indicates a particular type of the plural types of identifiers associated with the access node.

### EXAMPLE EMBODIMENT 15

The access node of example embodiment 14, wherein the processor circuitry is arranged to configure the transmitting entity identity information to comprise a number of repetitions of a particular secondary synchronization sequence in a time domain.

### EXAMPLE EMBODIMENT 16

The access node of example embodiment 14, wherein the processor circuitry is arranged to configure the transmitting entity identity information to comprise a number of repetitions of a particular secondary synchronization sequence in a frequency domain.

### EXAMPLE EMBODIMENT 17

The access node of example embodiment 14, wherein the processor circuitry is arranged to configure the transmitting entity identity information whereby subcarrier spacing for the secondary synchronization sequences indicates a number of the plural types of transmission identifiers expressed by the transmitting entity identity information.

### EXAMPLE EMBODIMENT 18

The access node of example embodiment 1, wherein the processor circuitry is arranged to express the transmitting entity identity information through broadcast information.

### EXAMPLE EMBODIMENT 19

The access node of example embodiment 18, wherein the processor circuitry is arranged to express the transmitting entity identity information using one or both of essential system information and on-demand system information.

### EXAMPLE EMBODIMENT 20

The access node of example embodiment 1, wherein the processor circuitry is arranged to express the transmitting entity identity information through dedicated signaling information.

### EXAMPLE EMBODIMENT 21

A method in an access node comprising:

using processor circuitry to generate transmitting entity identity information configured to express one or more plural types of transmission identifiers;

transmitting the transmitting entity identify information over a radio interface.

### EXAMPLE EMBODIMENT 22

A wireless terminal comprising:

a receiver configured to receive transmitting entity identify information over a radio interface;

processor circuitry configured to determine, from the transmitting entity identity information, one or more plural types of transmission identifiers.

### EXAMPLE EMBODIMENT 23

A method in a wireless terminal comprising:

receiving transmitting entity identify information over a radio interface;

using processor circuitry to determine, from the transmitting entity identity information, one or more plural types of transmission identifiers.

### EXAMPLE EMBODIMENT 24

A wireless terminal comprising:

receiver circuitry configured to receive a beam identifier over a radio interface from an access node;

processor circuitry configured to use the beam identifier to determine a synchronization signal block time index for a synchronization signal block that is associated with the beam identifier (BID).

### EXAMPLE EMBODIMENT 25

The wireless terminal of Example Embodiment 24, wherein the processor circuitry is configured to determine the synchronization signal block time index as being equal to the beam identifier.

### EXAMPLE EMBODIMENT 26

The wireless terminal of Example Embodiment 24, wherein the processor circuitry is configured to mathematically derive the synchronization signal block time index from the beam identifier.

### EXAMPLE EMBODIMENT 27

The wireless terminal of Example Embodiment 24, wherein the processor circuitry is configured to use the beam identifier in a mapping operation to ascertain the synchronization signal block time index.

### EXAMPLE EMBODIMENT 28

The wireless terminal of Example Embodiment 24, wherein the processor circuitry is further configured to use the synchronization signal block time index to determine a synchronization signal block type for a received synchronization signal block.

### EXAMPLE EMBODIMENT 29

The wireless terminal of Example Embodiment 24, wherein the beam identifier is determined per synchronization signal burst.

### EXAMPLE EMBODIMENT 30

The wireless terminal of Example Embodiment 24, wherein the beam identifier is determined per synchronization signal burst set.

### EXAMPLE EMBODIMENT 31

A method in a wireless terminal comprising:

receiving a beam identifier over a radio interface from an access node;

processor circuitry using the beam identifier to determine a synchronization signal block time index for a synchronization signal block that is associated with the beam identifier (BID).

### EXAMPLE EMBODIMENT 32

The method of Example Embodiment 31, further comprising the processor circuitry determining the synchronization signal block time index as being equal to the beam identifier.

### EXAMPLE EMBODIMENT 33

The method of Example Embodiment 31, further comprising the processor circuitry mathematically deriving the synchronization signal block time index from the beam identifier.

### EXAMPLE EMBODIMENT 34

The method of Example Embodiment 31, further comprising the processor circuitry using the beam identifier in a mapping operation to ascertain the synchronization signal block time index.

### EXAMPLE EMBODIMENT 35

The method of Example Embodiment 31, further comprising the processor circuitry using the synchronization signal block time index to determine a synchronization signal block type for a received synchronization signal block.

### EXAMPLE EMBODIMENT 36

The method of Example Embodiment 31, wherein the beam identifier is determined per synchronization signal burst.

### EXAMPLE EMBODIMENT 36

The method terminal of Example Embodiment 31, wherein the beam identifier is determined per synchronization signal burst set.

### EXAMPLE EMBODIMENT 37

A user equipment comprising:

receiving circuitry configured to receive, from a base station apparatus, a block of synchronization signals and a physical broadcast channel, the block composing a first sequence and a second sequence and a third sequence and a physical broadcast channel, wherein

the first sequence and the second sequence are used for identifying a physical layer cell identity, the first sequence being provided from 3 sequences, the second sequence being provided from 336 sequences, and

an index of the block is at least partially determined based on the third sequence.

### EXAMPLE EMBODIMENT 38

The user equipment according to Example Embodiment 37, wherein the index of the block is determined based on the third sequence and information carried by the physical broadcast channel.

### EXAMPLE EMBODIMENT 39

A base station apparatus comprising:

transmitting circuitry configured to transmit, to a user equipment, a block of synchronization signals and a physical broadcast channel, the block composing a first sequence and a second sequence and a third sequence and a physical broadcast channel, wherein

the first sequence and the second sequence are used for identifying a physical layer cell identity, the first sequence being provided from 3 sequences, the second sequence being provided from 336 sequences, and

an index of the block is at least partially based on the third sequence.

### EXAMPLE EMBODIMENT 40

The base station apparatus according to Example Embodiment 39, wherein the index of the block is based on the third sequence and information carried by the physical broadcast channel.

### EXAMPLE EMBODIMENT 41

A communication method of a user equipment comprising:

receiving, from a base station apparatus, a block of synchronization signals and a physical broadcast channel, the block composing a first sequence and a second sequence and a third sequence and a physical broadcast channel, wherein

the first sequence and the second sequence are used for identifying a physical layer cell identity, the first sequence being provided from 3 sequences, the second sequence being provided from 336 sequences, and

an index of the block is at least partially determined based on the third sequence.

### EXAMPLE EMBODIMENT 42

The communication method according to Example Embodiment 41, wherein the index of the block is determined based on the third sequence and information carried by the physical broadcast channel.

### EXAMPLE EMBODIMENT 43

A communication method of a base station apparatus comprising:

transmitting, to a user equipment, a block of synchronization signals and a physical broadcast channel, the block composing a first sequence and a second sequence and a third sequence and a physical broadcast channel, wherein

the first sequence and the second sequence are used for identifying a physical layer cell identity, the first sequence being provided from 3 sequences, the second sequence being provided from 336 sequences, and

an index of the block is at least partially based on the third sequence.

### EXAMPLE EMBODIMENT 44

The communication method according to Example Embodiment 43, wherein the index of the block is indicated based on the third sequence and information carried by the physical broadcast channel.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A user equipment comprising:
receiving circuitry configured to receive, from a base station apparatus, a block of synchronization signals and a physical broadcast channel, the block composing a first sequence and a second sequence and a third sequence and a physical broadcast channel, wherein
the first sequence and the second sequence are used for identifying a physical layer cell identity, the first sequence being provided from 3 sequences, the second sequence being provided from 336 sequences, and
an index of the block is at least partially determined based on the third sequence.

2. The user equipment according to claim 1, wherein the index of the block is determined based on the third sequence and information carried by the physical broadcast channel.

3. A base station apparatus comprising:
transmitting circuitry configured to transmit, to a user equipment, a block of synchronization signals and a physical broadcast channel, the block composing a first sequence and a second sequence and a third sequence and a physical broadcast channel, wherein
the first sequence and the second sequence are used for identifying a physical layer cell identity, the first sequence being provided from 3 sequences, the second sequence being provided from 336 sequences, and
an index of the block is at least partially based on the third sequence.

4. The base station apparatus according to claim 3, wherein the index of the block is based on the third sequence and information carried by the physical broadcast channel.

5. A communication method of a user equipment comprising:
receiving, from a base station apparatus, a block of synchronization signals and a physical broadcast channel, the block composing a first sequence and a second sequence and a third sequence and a physical broadcast channel, wherein
the first sequence and the second sequence are used for identifying a physical layer cell identity, the first sequence being provided from 3 sequences, the second sequence being provided from 336 sequences, and
an index of the block is at least partially determined based on the third sequence.

6. The communication method according to claim 5, wherein the index of the block is determined based on the third sequence and information carried by the physical broadcast channel.

7. A communication method of a base station apparatus comprising:
transmitting, to a user equipment, a block of synchronization signals and a physical broadcast channel, the block composing a first sequence and a second sequence and a third sequence and a physical broadcast channel, wherein
the first sequence and the second sequence are used for identifying a physical layer cell identity, the first sequence being provided from 3 sequences, the second sequence being provided from 336 sequences, and
an index of the block is at least partially based on the third sequence.

8. The communication method according to claim 7, wherein the index of the block is indicated based on the third sequence and information carried by the physical broadcast channel.
